(19) United States
(12) Patent Application Publication
(10) Pub. No.: US 2012/0253987 A1
(43) Pub. Date: Oct. 4, 2012

(54) METHOD FOR PROVISION OF INFORMATION OVER A NETWORK EMPLOYING USER DETERMINABLE PARAMETERS AFFECTING COST

(76) Inventor: Andrew Robinson, Takapuna (NZ)

(21) Appl. No.: 13/433,160

(22) Filed: Mar. 28, 2012

Related U.S. Application Data
(60) Provisional application No. 61/468,563, filed on Mar. 28, 2011.

(51) Int. Cl. G06Q 30/00

(52) U.S. Cl. 705/27.1

(57) ABSTRACT

An information provision system operated over the internet by a provider for communication of information to users communicating with the provider site. Information is provided to the user based upon one or a plurality of user chosen information providing quantifiers and priced accordingly. The quantifiers may be changed by the user in real time causing a change in price.

This application claims priority to U.S. Provisional Application Ser. No. 61/468563 filed on Mar. 28, 2011 and incorporated herein in its entirety by reference thereto.

### FIELD OF THE INVENTION

The invention disclosed and described relates to an information service. More particularly, the invention relates to an information service for providing users with information from experts and other sources over the internet, a wide area network, or a local area network, which allows the user to determine the speed, quality, and quantity of information in relation to the cost therefor.

### BACKGROUND OF THE INVENTION

This invention relates to an information service and has been devised particularly, though not necessarily solely, for providing information from information provider to seekers thereof, over the internet or a local or wide-area network.

Currently, various online publishers of information such as bloggers, and web page publishers, and authorities having a certain expertise in an area of information, can post information and receive comments on their information from viewers to their blog or web page.

The online publishers of information, or those who are experts or authorities in a certain field of endeavor, can also post an email address or a form which allows the online user to contact the online publisher of information directly.

However, currently, there remains a need for a system or service which allows the online publishers of information to sell their expertise to those seeking it. Such a system or service should also provide an inducement to online users looking for information, to seek information from specific online publishers of information over other sources.

Such a system should not only allow for written responses regarding the publisher's expertise, but should also allow for text and audio responses in real time, via online instant messenger or other means between publisher to users, or real time video conversations, between users and publishers of information, whereby consecutive questions and answers may be asked and answered with both parties in a real time communication, for a fuller understanding of the subject matter being requested by the user for the provider or publisher, and a fuller understanding of the information provided by the publisher to the inquiring user.

Still further, such a system should provide the user with a real time ability to choose from a plurality of individual quantifiers of the information they need, which will affect the information provided and the cost thereof in real time, according to each individual user's current requirements during a real time session.

The forgoing examples of related art and limitation related therewith are intended to be illustrative and not exclusive, and they do not imply any limitations on the invention described and claimed herein. Various limitations of the related art will become apparent to those skilled in the art upon a reading and understanding of the specification below and the accompanying drawings.

It is therefore an object of the present invention to provide an information service which will provide users seeking information from experts, and other sources, with the ability to find and retrieve such information.

It is an additional object of the present invention to provide an information service which will enable information providers and experts, to be found and communicate with users seeking information in their field of expertise.

Further, it is an object of the invention, to provide a portal for communication of such information, in real time, at a cost which changes depending on the user's individual choice of any of a plurality of price quantifiers which will change depending on the time frame, the quantity, and the quality, of the provided information.

It is a further object, to allow such real time changing in price or value of information provided, based on the user's choices for such, which may be made in real time, with such cost for the provided information allowing the user to change their requirements based on their budget.

It is a further object of the present invention to not only provide such information as both written responses subsequent to inquiries from submitting users and also provide for real time two-way communications via instant messenger or similar means or by online audio-visual communications, such as a web-cam or display, between information providers and users. Such information would be provided at a cost which changes depending on the user's individual choice of a plurality of quantifiers which will change the time frame, the quantity, the quality, of information. Based on the user's choices, in real time, the cost for the provided information is adjusted allowing the user to change their inputs based on their budget.

Further objects of the invention will be brought out in the following part of the specification, wherein detailed description is for the purpose of fully disclosing the invention without placing limitations thereon.

### SUMMARY OF THE INVENTION

Accordingly, a first particularly preferred mode of the invention consists of an information service comprising a service provider in communication with a wide area network such as the internet and reachable thereover for communication by users.

Information and material are made available on the network from the provider entity using a network accessible server having software adapted to the task of such communications. The provider entity server is engaged and in communication with the network and reachable by users seeking information. Such users in communication with the server provided by the provider or providing entity, are provided electronic means for the user to ascertain what information is available from the entity hosting the site or server using software adapted to the task of providing menus, site searches, listings of information available through the provider site, and by whom it is authored or provided. The interface software providing menus, listing, and search ability, thereafter provides hyperlinks to found information or sources and thereafter provides electronic communication means for the user to request information on a wide variety of subjects, from experts and other providers of such information, through communications in real time or subsequent, provided through the provider server.

The information chosen by the user from a menu, search engine on the provider site, or other means of ascertaining the information available through the providing server of the entity hosting the website or network interface, may thereafter be provided in one or a combination of means for information communication from a group consisting of at least, written form, electronic written form such as PDF, video, audio, real time conferencing, and other electronic and physical means for experts and hosts of such information, to communicate such to a user seeking it.

In accordance with at least one particularly preferred mode of the invention, in addition to providing a menu, search engine, or other means to determine that desired information is available to the that which user the user seeks, software adapted to the task and communicating with the user from the provider site or communicated by the provider, will communicate to the user options. These information options will affect the ultimate cost of the information to the user.

Once the user determines the information which is available on the provider site or through the provider site, which is desired by the user, the user may set their requirements for the provision or receipt of such information using software adapted to the task of providing a graphic interface which communicates a real time means for adjustment, of the user response requirements.

These user adjustments of response inputs, allow the user to communicate their adjusting needs for a response from or through the provider site. The user can communicate one or a plurality of different real time response requirement adjustments, through from a plurality of user response requirements, including the speed with which an information response is desired, the quantity of information in the response required, and the quantity of information in the response required.

This real time communication of response requirements to the provider is enabled by the provider site communicating to the user a graphic interface with sliding scales. The scales are adjustable by the user in real time, to communicate back to the provider, changes in user information requirements.

The system allows the user to adjust any or all of their specific information requirements, and see feedback in real time, any change in the cost for providing the desired response, using the designated user response requirements. It is noted and anticipated that the system using software adapted to the task and running on the communicating server of the information provider, may employ and communicate other means for graphic interface which allow the user to adjust information provision requirements in real time, and such should therefor not be considered limited to sliding scales only.

Consequently users seeking information at user chosen requirements, may receive such and adjust in real time, those requirements. Thus a user desiring a very fast response, of the highest quality from a world renowned expert in the field of the desired information, and in a large quantity, will see a higher cost than a user wishing for a slow response, from general industry sources, in a short response.

The user, employing the sliding scale or other graphic interface which will communicate their real time information provision requirements, and any adjustments to any or all of the user requirements, may thus get the quality of information they need for each project, in a time frame that fits their need, from a source of a quality needed for the project in question. Also in real time, the user may see their cost for the information they seek change on their local screen, according to their input parameters for speed, quality, and quantity of information, or other parameters which may apply to certain information types from certain expert or other sources providing through the system host or provider.

As such, users of the system, using the menu, search engine, or other software enabled means for ascertaining that the information they seek on a subject or matter, of any kind, may first determine such information is present on the system or available through the hosting provider. Subsequently, they may then determine how that information is to be provided according to their exacting input quantifiers for provision of information such as speed of response, quality of the information provided, and quantity of information or data provided, and the resulting cost for such in real time, even as the user adjusts.

With respect to the above description, before explaining at least one preferred embodiment of the herein disclosed user determinable information provision system in detail, it is to be understood that the invention is not limited in its application to the details of construction and to the arrangement of the components in the following description or illustrated in the drawings. The invention herein described is capable of other embodiments and of being practiced and carried out in various ways, which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other information provision methods and systems for carrying out the several purposes of the present disclosed user determinable provision system herein. It is important, therefore, that the claims be regarded as including such equivalent information provision systems and methodology insofar as they do not depart from the spirit and scope of the present invention.

Further, as used in the claims to describe the various inventive aspects and embodiments, “comprising” means including, but not limited to, whatever follows the word “comprising”. Thus, use of the term “comprising” indicates that the listed elements are required or mandatory, but that other elements are optional and mayor may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

### BRIEF DESCRIPTION OF THE DRAWINGS

The accompanying drawings, which are incorporated herein and form a part of the specification, illustrate some, but not the only or exclusive, examples of embodiments and/or features. It is intended that the embodiments and figures disclosed herein are to be considered illustrative rather than limiting. Those skilled in the art of software and web hosting and operating as servers and portals, will realize on reading this disclosure, that software enabling the communications noted herein is readily available and developable in a wide variety of styles, types, and for a wide variety of computer devices from business desktops to smartphones. As such, any software which may be employed to provide the communications between user and site host or provider herein, in the manner disclosed, is anticipated within the scope of this invention.

FIGS. 1-4 show depictions of typical graphic interface screens, communicated by software adapted to the task, running on servers of the system provider and user, and adapted for user input of desired information and response quantifiers or parameters, after the user has searched for, found, and communicated to the provider, the information they seek.

### DETAILED DESCRIPTION OF THE INVENTION

To be described in more detail in the following figures, the user, once they have been presented with menus, search engines, and other means to ascertain information they seek is available through the provider, will choose the information they require at with the information quantifiers they desire. This information chosen as the information type they require from the providing listings and menus of such information, is chosen by the user being afforded a graphic interface screen allowing real time user input as to the manner of provision of the information through the provider of the system.

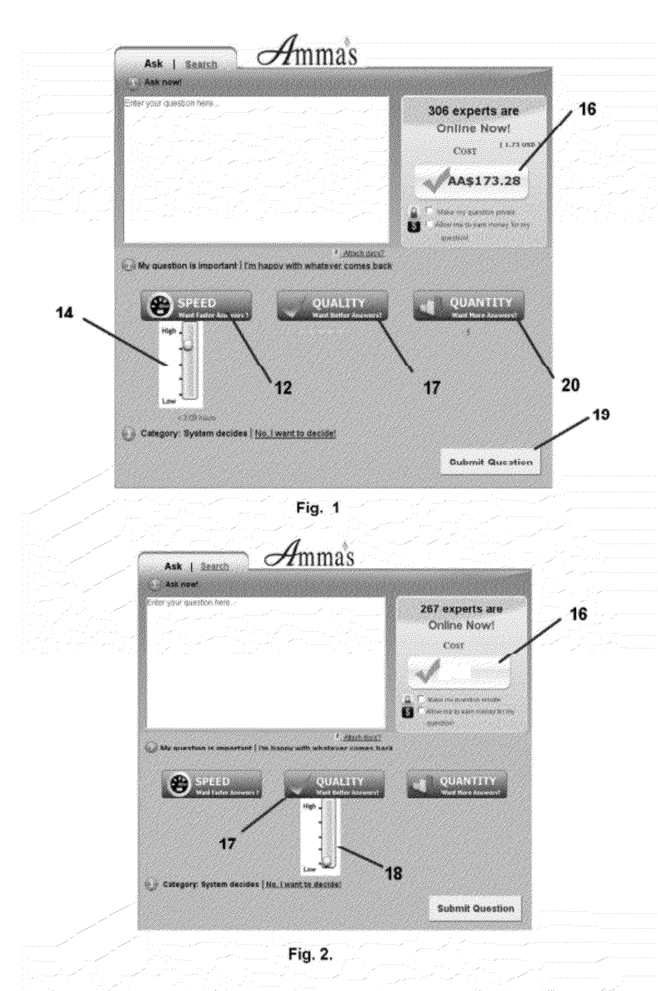

Now referring to drawings in FIGS. 1-4, wherein similar components are identified by like reference numerals, in FIG. 1 there is seen the provided graphic interfaces for real time user selection of quantifiers for information they seek. Such are software enable user determination for speed 12 response gauge with a user adjustable graphic interface to communicate choices and real time changes. For real time communication of all such user determined information provision quantifiers, graphic interfaces are communicated from the system provider server, such as a slider 14, thereby allowing a means for real time adjustment of the all the quantifiers such as the depicted speed parameter.

User real time changes in their information provision quantifers, result in a communicated price 16 which changes in a real time response to the user changes of any of the information provision quantifiers such as the depicted speed 12 requirement. Prior to the initiation of information communication from the expert through the provider site, the user is afforded a graphic means to input they wish to proceed such as a submit the question button 19. This graphic means to provide information requested using the requested information quantifiers, is activated by the user once they determine all of the parameters of the information quantifiers they wish.

Before further disclosure however, it should be noted and anticipated that although the invention is shown in its most simple form, with simple graphical interfaces and steps, various components and aspects of the system may be differently arranged or modified when forming the communication system invention herein. As such those skilled in the art will appreciate the descriptions and depictions set forth in this disclosure are merely meant to portray examples of preferred modes within the overall scope and intent of the invention, and are not to be considered limiting in any manner.

In FIG. 2 is shown the user determinable information quantifier in the area of quality 17 of response input. Again, it is depicted with a user employable real time communication showing a user adjustable slider 18 for real time adjustment of the communicated information quantifier of quality 17 of the provided response. For instance, the user may provision of information on a topic from an expert at one end of the graphic scale, or just common data from a known provider of information on the subject sought. Real time adjustments are communicated from the user to the system operator or provider, and will result in real time adjustments on price.

Again, it is noted that the system may employ any means for graphic interface which is suitable for the intended purpose, and is anticipated. The changes in the information provided price 16, will occur in a response to any real time user changes communicated in the information quantifier of desired quality 17 requirement, along with any one or a plurality of other information quantifiers the user may be provided, such as information quantifiers of speed 12 and quantity 20.

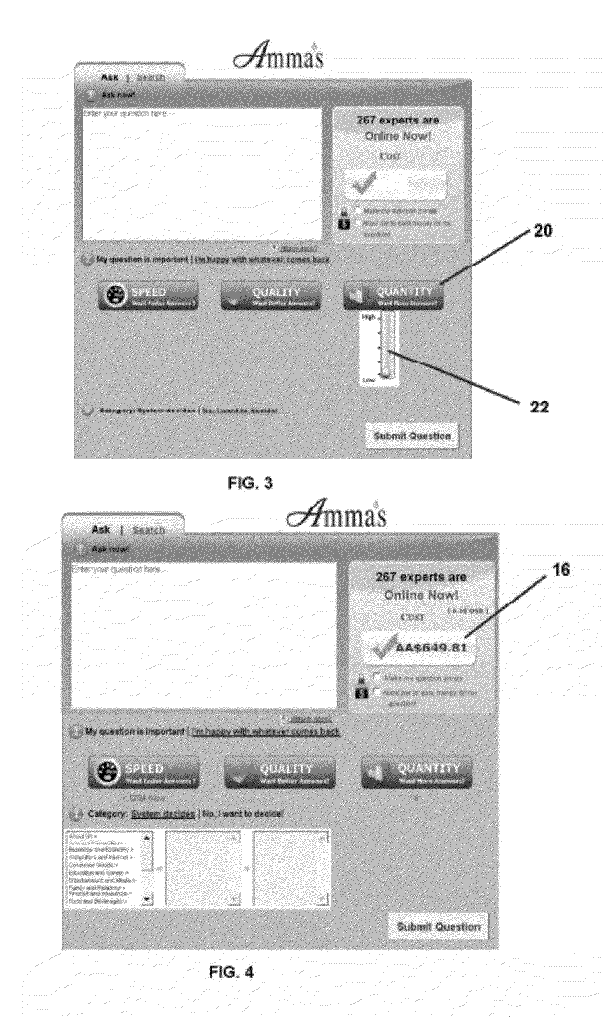

In FIG. 3 is shown the user determinable information quantifier of desired quantity 20 of response graphic input for communicating in real time their desire in this area of information provision quantifier. The user may change this information quantifier with the user adjustable slider 22 for communicating to the provider or system operator, a real time adjustment of the user desired quantifier of quantity 20 and or type of the provided response. For instance a printed response, or a PDF response, or a video and combinations thereof, in large volumes of data and information or short one page summaries.

The price 16 to the user changes in a response to the user changes of the information quantifier of quantity 20 requirement along with any other of a plurality of information quantifiers available to the user such as speed 12 of information provision, and/or information quality 17.

FIG. 4 depicts the price 16 of the information presented to the user once they have input one or a combination of their desired information quantifiers from a group of such quantifiers including speed 12, quality 17, and quantity 20 of provide information. Other quantifiers in the plurality offered for the user to adjust in real time, are anticipated depending on the type of information sought, and are considered included in this application and the claims herein.

The system herein may be employed on any networked or web-based or wide-area-network system providing communications and the ability to communicate information on subjects which may be found by users. Once the provider and user have communicated information is requested, information provision quantifiers are provided to the user and are adjustable by the user in real time to change the cost based on the user's input quantifiers.

Of course those skilled in the art will realize that there may be more or other user input information quantifiers which may be included in other modes of the system herein and any such input parameter or user determinable information provision quantifier which a user might desire in determining their need for a response or information as would occur to those skilled in the art is intended to be within the scope of this invention.

While all of the fundamental characteristics and features of the disclosed method and apparatus providing a network service for communication between publishers of information and users seeking it with a user input means quantifying delivery requirements with reference to particular embodiments thereof which have been shown and described, a latitude of modification, various changes and substitutions are intended in the foregoing disclosure and it will be apparent that in some instance, some features of the invention will be employed without a corresponding use of other features, or steps may be rearranged for operations, without departing from the scope of the invention as set forth.

It should be understood that such substitutions, modifications, and variations may be made by those skilled in the art without departing from the spirit or scope of the invention. Consequently, all such modifications and variations are included within the scope of the invention as defined herein.

What is claimed is:

1. A system providing information over a wide area network such as the Internet to users seeking sources of information comprising:
software running on a provider server or microprocessor configured for real time communication with users seeking information;
said software providing a graphic interface to users enabling said users to determine information available from said provider;
means for users to communicate one or a plurality of user chosen information quantifiers to said provider as to a desired information to be provided to said user;
means for communication to said user, a price for said information dependent on said user chosen quantifiers;
means for adjustment by said user of any of said one or plurality of user chosen information quantifiers and to communicate said adjustment to said provider;
means to communicate a real time change in said price, to said user in relation to any said adjustment by said user.

2. The system providing information of claim 1 wherein graphic interfaces are provided said user as said means for adjustment by said user of any one or plurality of said user chosen quantifiers.

3. The system providing information of claim 2 additionally comprising:
said user chosen quantifiers being any one or plurality from a group of quantifiers including, quality of said information, quantity of said information, and speed of provision of said information.

4. The system providing information of claim 3 additionally comprising:
said means for communication to said user, a price for said information dependent on said user chosen quantifiers is an electronically transmitted graphic display of price;
said means for adjustment by said user of any of said one or plurality of user chosen information quantifiers and to communicate said adjustment to said provider is a graphic interface displayable on said user's video screen which is adjustable by an input device communicating with said screen; and
said means to communicate a real time change in said price, to said user in relation to any said adjustment by said user is said electronically transmitted graphic display of price which changes in relation to said adjustments.
